(19) United States
(12) Patent Application Publication
(10) Pub. No.: US 2005/0052990 A1
(43) Pub. Date: Mar. 10, 2005

(54) Orthogonal frequency division multiplexing error vector magnitude calibration based on separate multi-tone measurement

(75) Inventor: Yuval Lomnitz, Herzelia (IL)

Correspondence Address: DR. MARK FRIEDMAN LTD.;C/o Bill Polkinghorn, Discovery Dispatch, 9003 Florin Way, Upper Marlboro, MD, 20772, US

(73) Assignee: Envara Ltd.

(21) Appl. No.: 10/658,367

(22) Filed: Sep. 10, 2003

(51) Int. Cl. H04J 11/00

(52) U.S. Cl. 370/208

(57) ABSTRACT

A method for estimating the error vector magnitude (EVM) of an OFDM signal comprises the steps of obtaining a multi-tone EVM of a separate multi-tone signal, and using the multi-tone EVM to estimate the OFDM EVM. The multi-tone signal is designed to have carriers that occupy a small fraction of OFDM bins, and its EVM is estimated from the ratio of sums of full bin energies and empty bin energies.

### FIELD OF THE INVENTION

The present invention relates generally to wireless communication systems and methods, and more particularly, to orthogonal frequency division multiplexing (OFDM) systems and methods.

### BACKGROUND OF THE INVENTION

Orthogonal frequency division multiplexing (OFDM), also known as MultiCarrier Modulation (MCM) or Discrete Multi-tone modulation (DMT), is a technique by which data is transmitted at a high rate by modulating several low bit rate carriers in parallel, rather than one high bit rate carrier. A detailed description of OFDM may be found in chapter 2 of “OFDM for Wireless Multimedia Communications,” Richard van Nee and Ramjee Prasad, Artech House Publishers, 2000, which is incorporated herein by reference. OFDM is spectrally efficient, and has been shown to be effective for high performance digital radio links. There are a number of application areas of OFDM including Wireless Asynchronous Transfer Mode (WATM), for high speed, short distance radio links between computer systems; Digital Audio Broadcasting (DAB), for high quality audio signals; and Microwave Video Distribution System (MVDS). OFDM signal transmission requires high linearity. This requirement is expressed by a requirement (criterion) on the error vector magnitude (EVM) of the transmitted signal. A definition of the EVM measurement may be found for example in the IEEE 802.11a standard (clause 17.3.9.7), which is incorporated herein by reference, and which requires EVM of at least 25 dB for the highest OFDM rate (54 Mbps). OFDM features based on the IEEE 802.11a standard are henceforth referred to as “802.11a OFDM”.

The limiting factor in OFDM transmission systems is usually the power amplifier (PA), which limits the maximum power that can be transmitted in order to satisfy the EVM requirement. The PA is the part of the transmitter used to amplify the signal, as one of the last stages before the antenna, and the likely source of linearity problems. In order to transmit with maximum power, is it desirable to calibrate the transmission power of the transceiver (e.g. in the factory process) to the maximal level possible under the EVM criterion. The reason OFDM requires a high dynamic range from the transmitter is its high peak to average (PAR) ratio. This is due to the fact that the occasional “peaks” of the signal are trimmed by causing saturation in the analog modulator, and distort the signal.

A direct measurement of the EVM is a complex task, which requires special equipment in order to demodulate the OFDM signal, including time and phase synchronization, to compare the received signal's constellation points with the ideal constellation points, and to average the Euclidian distance between the ideal and the received constellation points and produce the EVM. The procedure is explained in detail in the 802.11a standard (clause: 17.3.9.7). Due to the random nature of the OFDM signal, performing this task with good accuracy requires a considerable amount of data capture (the 802.11a standard requires 320 symbols).

Another type of solution is based on a measurement of in-band or out-of-band spectral growth, while transmitting an OFDM signal. By “spectral growth” we mean the increase or inflation in the signal spectrum (at a specific frequency, when the spectrum is normalized in some way) when the power is increased. The spectral growth is compared against results measured for the specific type of PA, linking these factors to the EVM. This kind of solution usually requires equipment such as a spectrum analyzer, and lacks the accuracy of a direct measurement. (see J. R. Paviol, Y. S. Ko and W. R. Eisenstadt, “Automating Engineering WLAN PA Distortion Test”, http://www.intersil.com/data/wp/wp0564.pdf (continuous multi-tone tests, with spectrum analyzer).

There is therefore a widely recognized need for, and it would be highly advantageous to have a simple method for estimating the OFDM EVM.

### SUMMARY OF THE INVENTION

The present invention discloses a method for quick and accurate measurement of the transmitter EVM by using a carefully selected multi-tone signal. This is done using only a small amount of data capture, and without time and phase synchronization. These advantages result from the periodic nature of the multi-tone signal, which is transmitted instead of the OFDM signal, and from its specific structure, explained in more detail below.

According to the present invention there is provided a method for EVM calibration of an OFDM signal transmitter comprising the steps of providing a separate multi-tone signal with unmodulated carriers, and estimating a multi-tone error vector magnitude of the separate multi-tone signal, whereby the multi-tone error vector magnitude is closely correlated with the OFDM error vector magnitude.

According to one feature in the method for EVM calibration of an OFDM signal transmitter of the present invention, the step of providing a separate multi-tone signal includes providing a multi-tone signal characterized by a plurality of unmodulated carriers set at OFDM bins frequencies and filling only a portion of the bins, the multi-tone signal thus including full bins and empty bins, and the step of estimating includes estimating an energy ratio between energies associated with the full bins and energies associated with the empty bins.

According to the present invention, the method for EVM calibration of an OFDM signal transmitter further comprises the steps of comparing the multi-tone EVM with a specified EVM, and setting a transmitter power based on the comparison.

According to the present invention there is provided a method for estimating the error vector magnitude (EVM) of an OFDM signal comprising the steps of providing a periodic multi-tone signal that includes a first plurality of full bins and a second plurality of empty bins, and obtaining the EVM of the OFDM signal from an estimation of an EVM of the multi-tone signal.

According to one feature in the method for estimating the EVM of an OFDM signal of the present invention, the full and the empty bins are chosen such that any third order inter-modulation product falls on an empty bin, and the multi-tone signal has a period equal to a period of the OFDM signal.

According to the present invention there is provided a method for estimating the EVM of an OFDM signal comprising the steps of obtaining a multi-tone EVM of a separate multi-tone signal, and using the multi-tone EVM to estimate the OFDM EVM, wherein the step of obtaining a multi-tone EVM includes: transmitting a multi-tone signal with a given transmitted power from a unit under test to a golden unit; using the golden unit to estimate and correct a frequency error of the multi-tone signal; recording a slice from the multi-tone signal; performing a transform on the slice; and estimating the multi-tone EVM from the results of the transform.

### BRIEF DESCRIPTION OF THE DRAWINGS

The invention is herein described, by way of example only, with reference to the accompanying drawings, wherein:

FIG. 1 illustrates the setup for performing an EVM measurement;

FIG. 2 shows a flowchart illustrating the method for multi-tone EVM measurement of the present invention;

FIG. 3 shows a typical multi-tone signal used in the method of the present invention;

FIG. 4 shows schematically an illustration of a multi-tone signal in the frequency domain: (a) before being passed through a distortion (e.g. PA), and (b) after distortion, showing that the intermodulation products fall on empty bins;

FIG. 5 shows a histogram of the I and Q components and amplitude, compared to ideal Gaussian and Rayleigh distributions;

FIG. 6 shows a comparison between the EVM of an OFDM signal and a multi-tone signal, both passed through a round hard clipper;

FIG. 7 shows the AM distortion y=x−x³/12 used for the synthetic comparison of a multi-tone based estimate and a true OFDM EVM;

FIG. 8 shows a comparison of the true EVM of the multi-tone, the estimated EVM of the multi-tone, and the true EVM of an OFDM signal, after passing the synthetic AM distortion;

FIG. 9 shows a comparison of EVM estimated by multi-tone with EVM measured on an OFDM signal, when injected into a Murata-2400PJ Power Amplifier;

FIG. 10 shows a comparison of EVM estimated by multi-tone with EVM measured on an OFDM signal, when injected into a MAX2247 Power Amplifier;

FIG. 11 shows a comparison of EVM estimated by multi-tone with EVM measured on an OFDM signal, when injected into an AR 213B Power Amplifier;

### DESCRIPTION OF THE PREFERRED EMBODIMENTS

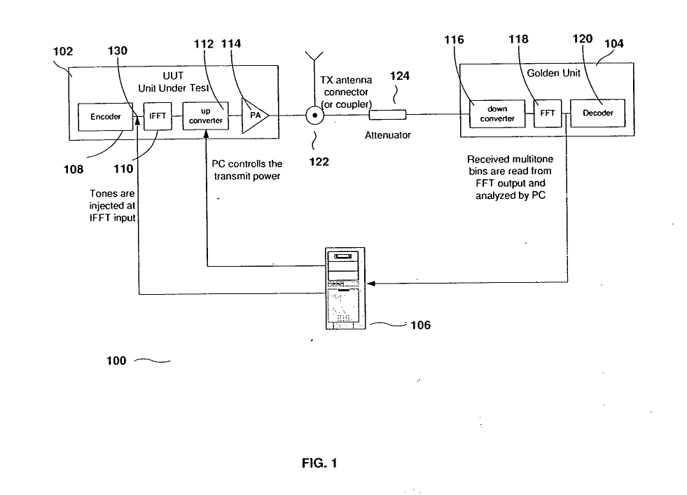

The present invention discloses a method for fast measurement of the error vector magnitude of an OFDM transmission system, the method using a multi-tone signal with special characteristics. A multi-tone signal is a combination of single-tone carriers. The multi-tone signal used is herein is similar to an OFDM signal, and produces a very accurate EVM estimate compared to an actual EVM value measured on the OFDM signal, its main difference from an OFDM signal being in that its carriers are un-modulated (no data is modulated on its carriers). Accordingly, the estimation of this multi-tone's EVM requires only the recording of a short (3.2 μs for 802.11a OFDM) slice from the multi-tone signal and a simple Fast Fourier Transform (FFT) operation, which can be implemented based on the OFDM receiver. Our purpose is to use a system such as system 100 in FIG. 1 to test a unit under test (UUT) together with the PA, in order to tune the correct power level that will give the required EVM when OFDM signals are transmitted.

FIG. 1 illustrates a system 100 preferably used to perform the multi-tone EVM measurement according to the present invention. System 100 comprises a UUT module 102 connected to a golden (calibrated) unit GU 104, both units connected to a computer, preferably a personal computer (PC) 106. The PC is used in, and controls a calibration process. UUT module 102 further comprises an encoder 108, an inverse FFT (IFFT) block 110, an up-converter 112 and a power amplifier (PA) 114, all connected in series. Golden unit 104 is a regular transceiver, used in this setup for receiving (demodulation) only. Its receive chain includes a down-converter 116, an FFT block 118 and a decoder 120, connected in series. The computer is able to read an output 122 of FFT block 118. All mentioned units (encoder/decoder, FFT/IFFT, up-converter/down-converter and PA) are an integral part of an OFDM transceiver hardware. The UUT is connected to GU 104 through a connector, preferably a TX antenna connector or coupler 124, and through an attenuator 126.

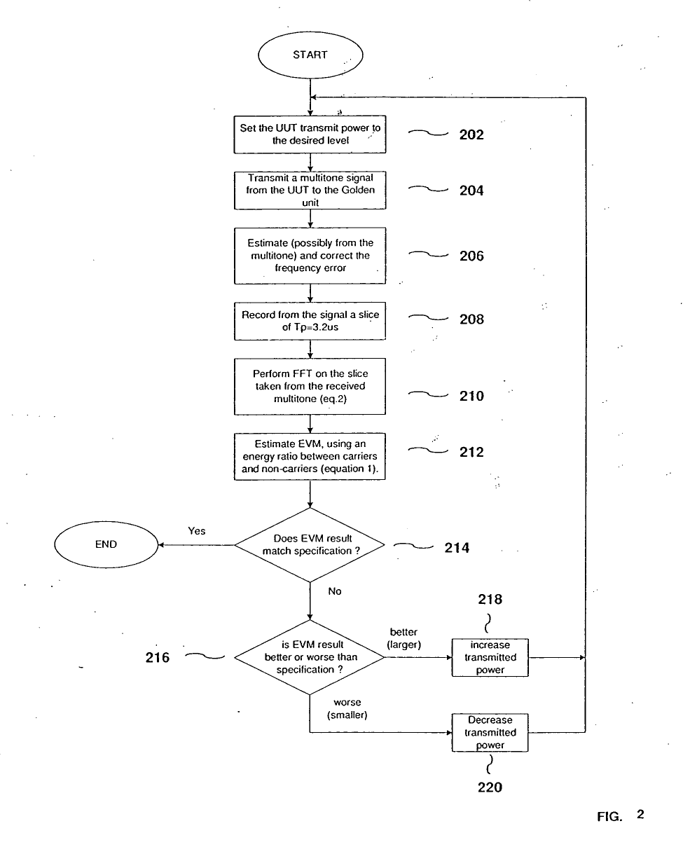

FIG. 2 shows a flowchart describing in more detail the steps of a preferred embodiment of the method for EVM estimation of the present invention. The PC sets the transmit power of the UUT (as well as frequency and other parameters desired to be scanned) in step 202, injects multi-tone bins (carriers) into the IFFT, and transmits the multi-tone signal to the GU in step 204. As with a normal OFDM signal, the multi-tone signal is up-converted in up-converter 112, transmitted through coupler/connector 124, attenuated in attenuator 126, and injected into the golden unit, where it is down-converted in down-converter 116. A frequency error is estimated and corrected by the GU in step 206, and a single slice, preferably 3.2 μs long for a 802.11 a OFDM, is cut from the signal in step 208. FFT block 118 performs a FFT operation on the single slice of the received multi-tone signal in step 210. The FFT results are read by the PC, analyzed, and the multi-tone EVM value is estimated in step 212 as described in further detail below. The EVM estimate is compared against a pre-defined specification in step 214. If the EVM is within the specification, the process is finished, and the reached transmit power (the transmit power that yields the specified EVM) is recorded. If the EVM is better than the specification (step 216), the transmitted power is increased in step 218 and another iteration is performed. If the EVM is worse than the specification, the transmitted power is decreased in step 220 before repeating the process. Comparisons against specifications are well known in the art. The step size by which the transmitted power is increased or decreased is designed to accommodate the required accuracy of the process, while taking into account the required convergence time. A typical step would be 0.5-1 dB. The present invention is concerned only with the steps relevant to the estimation of the EVM (steps 204-212). The iterative process for finding the transmitted power that yields a specified EVM (steps 202, 214-220) is presented herein as a simple example. Other, faster processes may be devised to find the transmitted power (for example, using interpolation), while using the multi-tone-based EVM estimation method (steps 204-212).

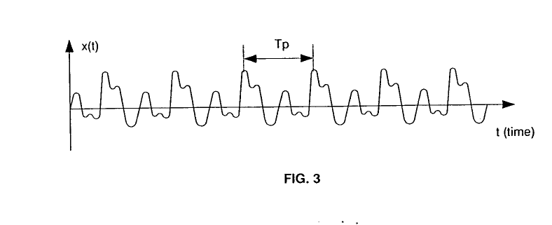

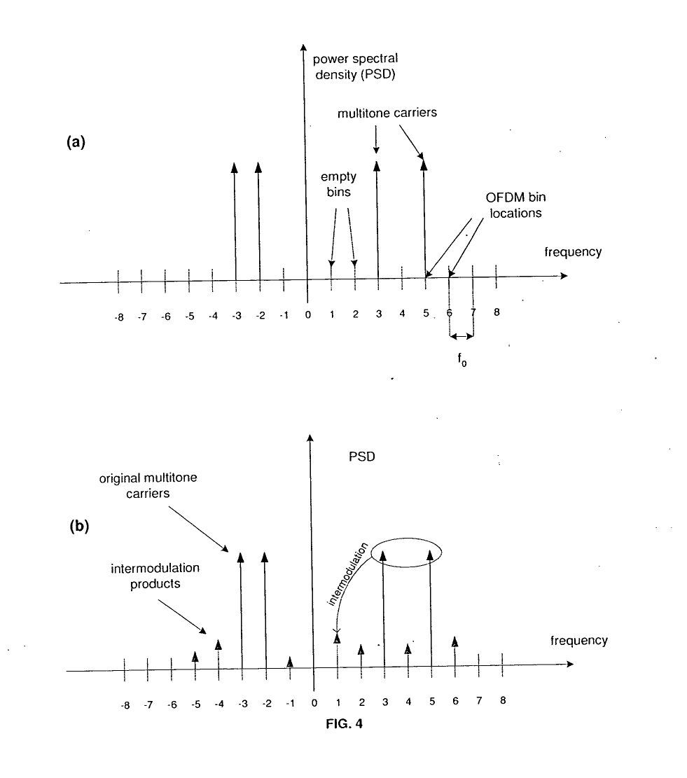

The considerations in the choice of the multi-tone characteristics for the purposes of the present invention are described now in more detail. FIG. 3 shows a typical multi-tone signal used in the method of the present invention in the time domain. FIG. 4 shows schematically a multi-tone signal in the frequency domain: (a) before being passed through a distortion (e.g. the PA), and (b) after the distortion. The carriers of the multi-tone signal are chosen at OFDM bin frequencies so as to enable production and reception of these carriers using the operational OFDM transceiver. In addition, the multi-tone bins are preferably selected to have the same amplitude, and are preferably chosen from a BSPK (−1, 1) or a QPSK (1, j, −1, −j) constellation. A main consideration for setting all carriers to the same amplitude is that in order to obtain maximum Gaussian matching (see below) under a constraint of a fixed number of tones (“minimum number of tones” criterion below), the amplitudes of the tones should be more or less equal.

The EVM measurement method of the present invention advantageously does not rely on time or phase synchronization between the receiver and the transmitter. To simplify the EVM measurement, the multi-tone signal is chosen so that only a small part (20%-30%) of the bins (carriers) are actually filled. FIG. 4a clearly shows that the multi-tone carriers “fill” or occupy only some OFDM bins (e.g. −3, −2, 6, 7), while the other shown OFDM bins are empty. FIG. 4b clearly shows that after the distortion, there are inter-modulation products visible on the empty bins (i.e. −5, −4, −1, 1, 2, 4, 6 etc). Preferably, the carriers (bins) are further designed so that any 3^{rd} order inter-modulation product (2·f₁−f₂ where f₁ and f₂ are carrier frequencies) of a transmitted bin falls on an empty bin. For example, as illustrated in FIG. 4b, one of the inter-modulation products of f₁=3f₀ and f₂=5f₀ is 2·f₁−f₂=1·f₀, and therefore bin 1 is left empty for this inter-modulation product. Since only a small percentage of the bins are occupied bins, most higher-order inter-modulation products will also be located on empty bins. This allows easy and simple measurement of the inter-modulation products by GU receiver 120, after the FFT operation. We call this a “minimum number of tones” requirement. Finally, we estimate the EVM of the multi-tone using the sum of the energy of all bins divided by the sum of the energy on non-carriers (i.e. empty bins), see eq. (1) below. These energies are measured by the GU receiver. This gives an approximation of the error-vector absolute value, assuming that the error vector spectrum is almost entirely composed of carriers that are not the carriers selected for the multi-tone.

Measuring EVM or spectral growth on actual OFDM signals takes a long time because of the required averaging (due to the stochastic nature of the signal). The multi-tone signal in the present invention is periodic and selected to have a short period Tₚ. As seen in FIG. 3, any section of length Tₚ starting anywhere along the time axis includes a whole period, and therefore all the necessary information. In the specific case of an 802.11a OFDM signal, Tₚ=3.2 μs, same as the symbol time (without the prefix), which is also described in the 802.11a reference. However, the method described herein is general, being applicable to other OFDM type techniques such as MCM, DMT, etc., in which case Tₚ may assume other values. Since the multi-tone signal is periodic, after the PA distortion it will remain periodic, and a measurement of the Tₚ of the received multi-tone signal suffices to estimate the spectrum or any other property of the signal.

### Signal Amplitude Distribution

An OFDM signal typically has a near Gaussian distribution of the In-phase (I) and Quadrature (Q) elements, and consequently, a Rayleigh distribution of the signal's amplitude. This distribution is the main factor affecting the relation between the transmitted power and the EVM (since the EVM is affected by the probability of saturation, caused by a large instantaneous amplitude), see chapter 6 in ““OFDM for Wireless Multimedia Communications,” Richard van Nee and Ramjee Prasad, Artech House Publishers, 2000”.

In order to obtain a power-EVM relation for the multi-tone as close as possible to that of the OFDM signal, the distributions (histograms) of the I, Q and amplitude of the multi-tone signal should be as close as possible to those of OFDM. The similarity of the distributions is measured by histograms, and also by comparing the EVM created by circular clipping of the multi-tone signal with a theoretical result for an OFDM signal. In order to achieve maximum Gaussianity, the number of carriers should be as large as possible. We call this “a maximum number of carriers for Gaussian matching” requirement. The two requirements (minimum number of tones vs. maximum number of carriers for Gaussian matching) contradict each other. A preferred tradeoff is using around 20%-30% of the carriers, i.e. 10-16 of the 52 carriers in the case of 802.11a OFDM.

### Frequency Offset

In order to attain the correct EVM, the reconstruction of the multi-tone bins at the receiver (i.e. at the FFT output in the golden unit) must be performed after frequency offset correction, to compensate for the local oscillator (LO) frequency difference between the UUT and the GU cards. Most OFDM receivers include a mechanism for estimation and correction of this error, e.g. by auto-correlation, which can also be applied to the multi-tone signal. Therefore, the reconstruction is easy to perform, since it uses capabilities that already exist in standard OFDM transceivers.

Note that frequency estimation in 802.11a OFDM systems is normally performed by auto-correlating two 3.2 μs sections of the signal, to find the phase growth that evolved during 3.2 μs. Instead of performing this process on the two long preamble symbols in real 802.11a OFDM frames, as normally done, the process can be performed on the multi-tone signal. This frequency estimation method has an ambiguity of 1/3.2 μs=312.5 Khz, which exactly equals the carrier.spacing (f₀) of OFDM. That is, if the frequency difference between the transmitter and the receiver Δf is greater than 156.25 Khz, it would mistakenly be estimated as Δf−312.5 Khz. This ambiguity does not create a problem in the implementation of this invention, since an estimation error of 312.5 Khz·n (where n is whole number) merely shifts the FFT output by n places. A convenient way of resolving this shift ambiguity when estimating the EVM is by distinguishing the carriers from the inter-modulation products (see eq. (1) below), not according to their known frequencies, but rather using other criteria (such as their amplitude). This would normally be performed in PC 106.

### Degradation Due to Channel Estimation

When measuring EVM on an 802.11a OFDM frame, the channel is estimated from the 6.4 μs long preamble. This channel estimation, which is also applied when testing EVM, has the effect of increasing the noise level by 1.76 dB in a flat channel (a factor of 1.5, since by using the equivalent of two symbols for channel estimation, the noise on the estimation is half the noise on data bins). Since no channel estimation is done for the multi-tone signal of the present invention, we artificially decrease (for 802.11a OFDM frames) a “noise factor” of 1.76 dB from the multi-tone EVM estimate to obtain the EVM estimate of an OFDM signal with the same power. In general, the noise factor may be a different number, according the specific signal.

### Expression for Multi-tone EVM Estimation

The EVM value estimated from the multi-tone according to the present invention is obtained from the following expression:

$$EVM = Const \cdot \frac{{\sum }_{k} \vert {\hat{x}}_{k} {\vert}^{2}}{{\sum }_{k ∉ \{ multitone bins \}} \vert {\hat{x}}_{k} {\vert}^{2}} \qquad ( 1 )$$

in which the numerator denotes the sum of energies of all bins (“carriers”), and the denominator denotes the sum of energies of empty bins (“non-carriers”). The constant “Const” can be used to compensate for losses inherent in the EVM estimation process. When using this method for a 802.11a OFDM system, Const is set to

$$Const = \frac{1}{1.5}$$

which compensates for the degradation that occurs due to channel estimation, as explained above. \hat{x}ₖ is the k'th FFT bin and it is defined in eq. (2):

$${\hat{x}}_{k} = {\int }_{0}^{{T}_{s}} x ( t ) \cdot {ⅇ}^{- j 2 π \cdot {f}_{0} \cdot k \cdot t} \cdot {ⅇ}^{- j 2 π \cdot Δ f \cdot t} ⅆ t \qquad ( 2 )$$

Eq.2 is a CDFT (continuous-to-discrete Fourier transform) of a single period from the signal, after frequency correction by Δf. In an actual receiver, it is implemented by several stages such as filtering, sampling, mixing (frequency correction), and finally FF. x(t) is the received signal in base-band (complex envelope) representation. Tₛ is the symbol length (3.2 μs in 802.11a), ƒ₀ is the OFDM bin separation (usually 1/Tₛ), and Δf is the estimated frequency offset between the transmitter and the receiver. Equation (1) summarizes the points mentioned above, i.e. that the EVM is estimated as a ratio of energies, and that a 1.5 factor is used to compensate for the channel estimation. This EVM estimate in eq. 1 is given on linear (not in dB) scale. If needed, it can be converted to dB by 10·log₁₀(EVM).

### EXAMPLE

Table 1 shows an exemplary multi-tone signal, selected according to the criteria above. This signal was generated by an automatic search program, which randomly selects frequencies matching the criteria, and selects the multi-tone combinations with best matching of the EVM under hard-clipping to that of an OFDM signal. The multi-tone consists of 10 out of 52 OFDM sub-carriers, which are located as follows:

TABLE 1

| | | | | | | | | | | |
|---|---|---|---|---|---|---|---|---|---|---|
| Carrier | −21 | −3 | 5 | 8 | 12 | 13 | 16 | 17 | 22 | 25 |
| Value | +j | +1 | −1 | +j | +j | +1 | +1 | −j | −1 | +j |

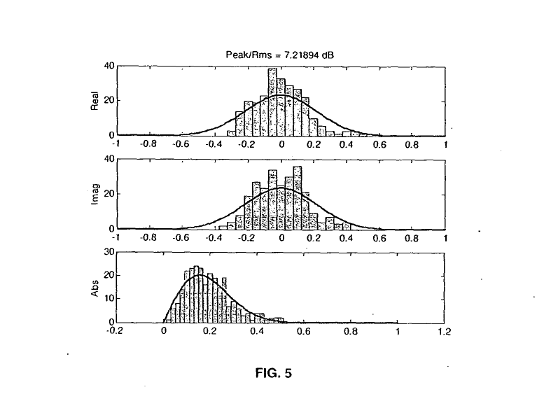

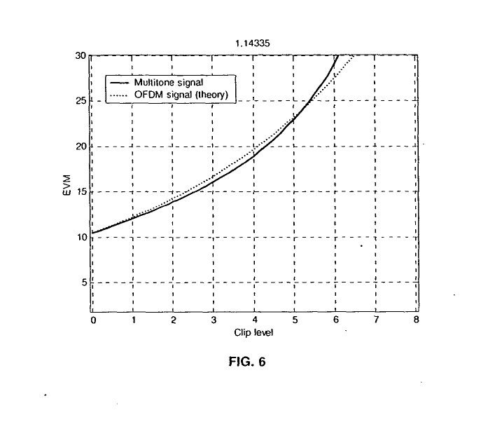

The multitone signal (before distortion) can be written in base-band representation as the following complex signal:

$$y ( t ) = {\sum }_{n = 1}^{N} {a}_{n} \cdot {ⅇ}^{j \cdot 2 π \cdot {f}_{n} \cdot t} \qquad ( 3 )$$

where N is the number of carriers in the multitone (in this case N=10), αₙ are their values (as they appear in Table 1) and ƒₙ are their frequencies. The carrier frequencies are the product of the carrier number cₙ (from Table 1), and the carrier spacing ƒ₀=312.5 Khz, i.e. ƒₙ=cₙ·ƒ₀. The signal is 3.2 μs periodic and has a PAR of 7.2 dB. FIG. 5 shows a histogram of the I (top) and Q (middle) components, as well as the amplitude (bottom) of the multi-tone signal, compared to ideal Gaussian and Rayleigh distributions with the same variance. FIG. 6 shows a comparison between the EVM of an OFDM signal and of this multi-tone, both passed through a round hard clipper.

### Simulation Results

The method of the present invention is further illustrated using a synthetic comparison (using a MatLab program) in which a multi-tone signal and an OFDM frame (according to the 802.11a standard, 1000 Bytes long, in data rate 9 Mbps) were passed through a

$$y = x - \frac{1}{12} {x}^{3}$$

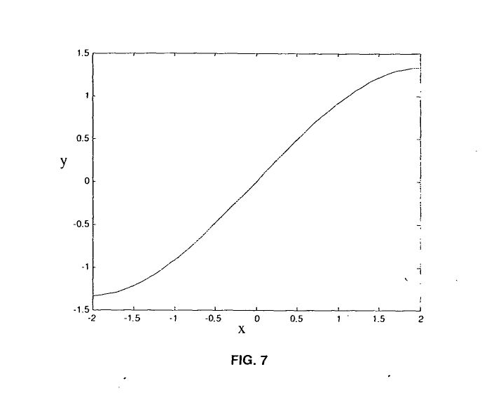

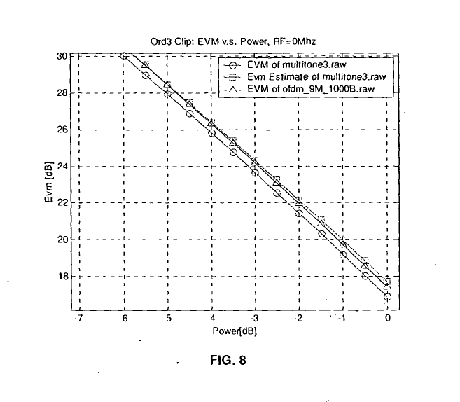

AM distortion, shown in FIG. 7. The true EVM of the OFDM and the multi-tone signal were measured, and the EVM estimate according to the present invention was calculated as function of the transmit power. The EVM values of the OFDM signal and of the multi-tone based estimate do not include the loss for channel estimation. FIG. 8 shows the comparison of the true (measured) multi-tone EVM, the estimated multi-tone EVM and the true (measured) OFDM EVM values. One can see the excellent agreement between the EVM estimated from the multi-tone signal, and the two measured EVMs.

### Experimental Results

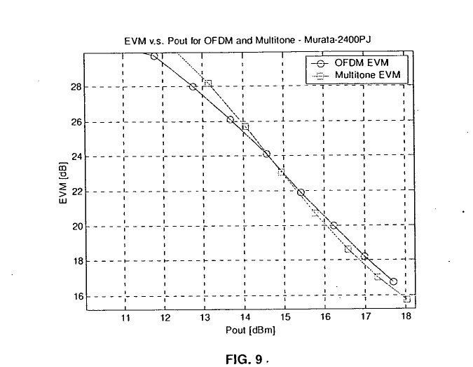

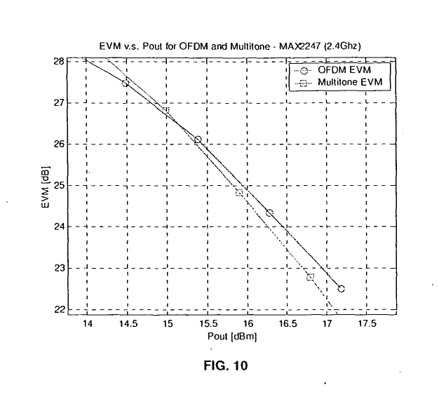

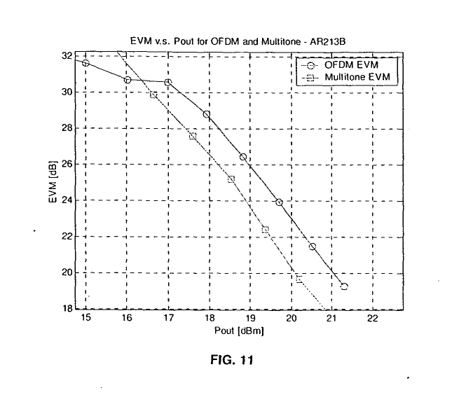

The method disclosed herein was further verified using experiments run with real power amplifiers. FIGS. 9-11 show comparisons of the true EVM value vs. RF output power, measured on an OFDM signal transmitted through a power amplifier, with the EVM value estimated from a multi-tone transmitted through the same power amplifier. Both signals were transmitted in RF frequency of 2.4 Ghz, down-converted to baseband, recorded and analyzed digitally (using the expressions from equation 1 for the multi-tone, and the 802.11a standard EVM definitions for OFDM). In FIG. 9 the signals were injected into a Murata-2400PJ Power Amplifier, in FIG. 10 into a MAX2247 Power Amplifier, and in FIG. 11 into an AR 213B Power Amplifier. The figures show an excellent match (less than 1 dB error) between the EVM estimate and the actual EVM obtained for the OFDM signal.

All publications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made. Those skilled in the art will appreciate that the invention can be embodied by other forms and ways, without losing the scope of the invention. The embodiments described herein should be considered as illustrative and not restrictive.

1. A method for error vector magnitude (EVM) calibration of an OFDM signal transmitter comprising the steps of:
a. providing a separate multi-tone signal with unmodulated carriers; and
b. estimating a multi-tone error vector magnitude of said separate multi-tone signal, whereby said multi-tone error vector magnitude is closely correlated with the OFDM error vector magnitude.

2. The method of claim 1, wherein said step of providing a separate multi-tone signal includes providing a multi-tone signal characterized by a plurality of unmodulated carriers set at OFDM bins frequencies and filling only a portion of said OFDM bins, whereby said separate multi-tone signal thus includes full bins and empty bins.

3. The method of claim 2, wherein the number of said full bins is equal to between 20-30 percent of the number of said OFDM bins.

4. The method of claim 1, wherein said step of providing a separate multi-tone signal further includes transmitting said multi-tone signal from a unit under test (UUT) to a golden unit (GU), and wherein said step of estimating a multi-tone error vector magnitude of said multi-tone signal include estimating from said multi-tone a frequency offset Δƒ between said UUT and said GU, correcting said frequency offset, performing a FFT operation on a slice of said frequency offset multi-tone, and estimating said EVM from said results of said FFT operation.

5. The method of claim 4, wherein said FFT operation is performed according to
$${\hat{x}}_{k} = {\int }_{0}^{{T}_{s}} x ( t ) \cdot {ⅇ}^{- j 2 π \cdot {f}_{0} \cdot k \cdot t} \cdot {ⅇ}^{- j 2 π \cdot Δ f \cdot t} ⅆ t ,$$
wherein ƒ₀ is an OFDM bin separation related to said symbol length.

6. The method of claim 2, wherein said step of estimating includes estimating an energy ratio between energies associated with said full bins and energies associated with said empty bins according to
$$EVM = Const \cdot \frac{{\sum }_{k} \vert {\hat{x}}_{k} {\vert}^{2}}{{\sum }_{k ∉ \{ multitone bins \}} \vert {\hat{x}}_{k} {\vert}^{2}} .$$

7. The method of claim 1, further comprising the steps of comparing said multi-tone EVM with a specified EVM, and adjusting a transmitter power based on said comparison.

8. The method of claim 2, wherein said full and said empty bins are chosen such that any third order inter-modulation product falls on an empty bin.

9. The method of claim 1, implemented according to the IEEE 802.11a standard.

10. The method of claim 1, further comprising the step of calibrating the OFDM signal EVM based on said multi-tone EVM.

11. A method for estimating the error vector magnitude (EVM) of an OFDM signal comprising the steps of:
a. providing a periodic multi-tone signal that includes a first plurality of full bins and a second plurality of empty bins; and
b. obtaining the EVM of the OFDM signal from an estimation of an EVM of said multi-tone signal.

12. The method of claim 11, wherein said full and said empty bins are chosen such that any third order inter-modulation product falls on an empty bin.

13. The method of claim 11, wherein said periodic multi-tone signal has a period equal to a period of the OFDM signal.

14. The method of claim 11, wherein said first plurality of full bins is equal to between 20-30 percent of the number of OFDM signal bins.

15. The method of claim 11, wherein said estimation of an EVM of said multi-tone signal includes computing an energy ratio between energies associated with said full bins and energies associated with said empty bins according to
$$EVM = Const \cdot \frac{{\sum }_{k} \vert {\hat{x}}_{k} {\vert}^{2}}{{\sum }_{k ∉ \{ multitone bins \}} \vert {\hat{x}}_{k} {\vert}^{2}} .$$

16. The method of claim 15, wherein said step of obtaining the EVM of the OFDM signal further includes subtracting a noise factor from said multi-tone EVM estimate.

17. The method of claim 16, implemented according to the IEEE 802.11a standard.

18. The method of claim 17, wherein said noise factor is 1.76 dB.

19. A method for estimating the error vector magnitude (EVM) of an OFDM signal comprising the steps of:
a. obtaining a multi-tone EVM of a separate multi-tone signal; and
b. using said multi-tone EVM to estimate the OFDM EVM.

20. The method of claim 19, wherein said step of obtaining a multi-tone EVM includes:
i. transmitting a multi-tone signal with a given transmitted power from a unit under test to a golden unit;
ii. using said golden unit to estimate and correct a frequency error of said multi-tone signal;
iii. recoding a slice from said multi-tone signal;
iv. performing a transform on said slice; and
v. estimating said multi-tone EVM from the results of said transform.

21. The method of claim 19, wherein said step of using said multi-tone EVM to estimate the OFDM EVM includes comparing said multi-tone EVM to a pre-defined specification, and increasing or decreasing said transmitted power when said multi-tone EVM estimate is above or below the specification, respectively.
